(19) United States
(12) Patent Application Publication
(10) Pub. No.: US 2018/0065705 A1
(43) Pub. Date: Mar. 8, 2018

(54) BICYCLE FRAME HAVING A BATTERY HOUSING UNIT

(71) Applicants: HYUNDAI MOTOR COMPANY, SEOUL (KR); KIA MOTORS CORPORATION, SEOUL (KR)

(72) Inventors: Jungnam CHOI, Seongnam-si (KR); Sung Dae LIM, Gunpo-si (KR)

(73) Assignees: HYUNDAI MOTOR COMPANY, SEOUL (KR); KIA MOTORS CORPORATION, SEOUL (KR)

(21) Appl. No.: 15/695,577

(22) Filed: Sep. 5, 2017

(30) Foreign Application Priority Data
Sep. 8, 2016 (KR) 10-2016-0115746

(51) Int. Cl. B62K 19/40; B62M 6/90; B62J 11/00; B60K 1/04; B60R 16/04; B62K 19/26; B62K 19/20

(52) U.S. Cl. CPC B62K 19/40; B62M 6/90; B62J 11/00; B60K 2001/0472; B60R 16/04; B62K 19/26; B62K 19/20; B60K 1/04

(57) ABSTRACT

The present disclosure provides a bicycle frame formed in a tube structure by bonding a left panel and a right panel together along a length direction, where the left panel and the right panel are molded into a predetermined shape, including: a battery housing unit and a reinforcement panel having a housing unit, wherein a battery is inserted into the housing unit, and wherein edges of the reinforcement panel are bonded to the left panel and the right panel.

### CROSS-REFERENCE TO RELATED APPLICATION

The present application claims priority to and the benefit of Korean Patent Application No. 10-2016-0115746, filed on Sep. 8, 2016, which is incorporated herein by reference in its entirety.

### FIELD

The present disclosure relates to a bicycle frame formed by stamping a left panel and a right panel and bonding the left panel and the right panel to each other, and having a battery housing portion where a battery is inserted into one side of a tube.

### BACKGROUND

The statements in this section merely provide background information related to the present disclosure and may not constitute prior art.

A conventional bicycle frame is formed of a head tube, a seat tube, a top tube, a down tube, a seat stay, and a chain stay.

A steering handing connection body is connected to an upper end of the head tube, a front wheel rotation connection body is connected to a lower end of the head tube, a saddle connection body is connected to an upper end of the seat tube, and a chain driver is connected to a lower end of the seat tube.

The top tube and the down tube connect the head tube and the seat tube for supporting the head tube and the seat tube, and the seat stay and the chain stay support a rear wheel rotation connection body and the seat tube by connecting the rear wheel rotation connection body and the seat tube.

The bicycle frame includes both the top tube and the down tube, but a main tube may be connected between the head tube and the seat tube as necessary.

The conventional bicycle frame is manufactured by cutting a top tube, a down tube, and a seat tube, respectively, using a tube as a main material, and respectively welding them, but productivity is deteriorated and production cost may be increased because the manufacturing process is difficult to automate.

Thus, recently, a study on improving productivity in manufacturing of the bicycle frame has been conducted, which relates to performing hot stamping on a plate material and bonding left and right portions thereof together.

In addition, an electric motor has been applied as a power source of the bicycle. As a result, a study on a structure for mounting a battery to apply power to the electric motor is also progressing.

However, an existing battery is excessively exposed to the outside of the frame so that the battery may be scratched or broken when the bicycle falls down to the left or right.

The related information is further disclosed in Korean Patent Publication No. 10-2011-0023604.

### SUMMARY

The present disclosure provides a bicycle frame having a battery housing unit which enables to detach a battery easily as well as protect the battery through a structure where the battery is inserted into a tube of the frame.

In some forms of the present disclosure, a bicycle frame formed in a tube structure by bonding a left panel and a right panel together along a length direction, where the left panel and the right panel are molded into a predetermined shape. The bicycle frame includes a battery housing unit, and a reinforcement panel having a housing unit, wherein a battery is inserted into the housing unit, and edges of the reinforcement panel may be bonded to the left panel and the right panel.

The reinforcement panel may be configured to combine at least one of a top tube, a seat tube, or a main tube with a down tube, and the down tube is connected to a head tube where a steering handle is provided

A motor mounting unit may be formed in at least one of a lower portion of the down tube or the top tube, and a motor for driving is provided in the motor mounting unit.

The housing unit may be opened downwardly such that the battery may be inserted into the housing unit from a bottom direction to atop direction.

The housing unit may be opened upwardly such that the battery may be inserted into the housing unit from the top direction to the bottom direction.

The housing unit may be opened laterally such that the battery may be laterally inserted into the housing unit.

The reinforcement panel and at least one of the left panel or the right panel may be bonded to each other by a rivet.

The reinforcement panel and at least one of the left panel or the right panel may be welded to each other.

The left panel or the right panel may be bonded to the reinforcement panel by hemming.

The bicycle frame having the battery housing unit may further include a separation prevention unit of which one end is fixed to at least one of the left panel or the right panel and the other end is detachably attached to at least one of the right panel or the left panel to prevent the battery from being separated from the housing unit.

The separation prevention unit may be a strap made of a flexible material or a clamp that is capable of being folded and unfolded through a link structure.

The bicycle frame may include a detachable unit configured to fix the other end of the strap or the clamp to the right panel or the left panel.

A bead may be formed in an inner surface or an outer surface of the reinforcement panel.

In some forms of the present disclosure, the battery is mounted by being inserted into the housing portion of the reinforcement panel such that the battery can be stably protected from external impact.

Further, a cutout portion is formed between the left and right panels in one side tube of the bicycle frame. Also, the reinforcement panel where the housing portion that receives the battery is prepared, and the edges of the reinforcement panel are bonded to edges of the cutout. As a result, the overall rigidity of the frame can be improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view of a bicycle frame;

FIG. 2 and FIG. 3 are cross-sectional views of FIG. 1, taken along the line II-II;

FIG. 4 is a cross-sectional view of a bonding structure between a left panel and a right panel and a reinforcement panel of the bicycle frame;

FIG. 5 is a side view and a partial exploded perspective view of a bicycle frame;

FIG. 6 is a side view and a cross-sectional view of a bicycle frame; and

FIG. 7 shows side views of bicycle frames.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

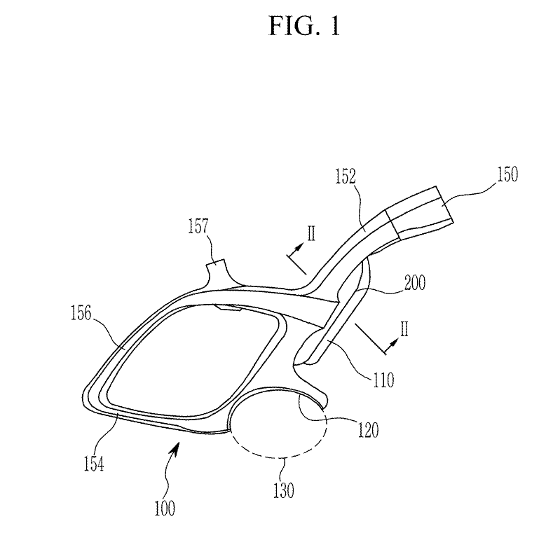

FIG. 1 is a side view of a bicycle frame in some forms of the present disclosure.

Referring to FIG. 1, a bicycle frame 100 includes a head tube 150, a seat stay 156, a chain stay 154, a motor unit 130, a motor mounting unit 120, and a main tube 152.

An upper end of the main tube 152 is connected to the head tube 150, a lower end of the main tube 152 is connected to the motor mounting portion 120, and the seat stay 156 is integrally connected at a middle of the main tube 152. In addition, a lower end portion of the seat stay 156 is integrally connected to a rear end of the chain stay 154, and a front end of the chain stay 154 is integrally connected to the motor mounting unit 120.

A bicycle steering handing (not shown) is vertically inserted into the head tube 150, and a seat tube 158 where a saddle is mounted on an upper portion is integrally formed in a center of the seat stay 156.

In a portion where the seat stay 156 and the main tube 152 are connected with each other, a battery 110 is inserted into a lower portion of the main tube 152, and the battery 110 is partially exposed to the outside.

A structure of the motor unit 130 mounted to the motor mounting unit 120 is well known technology, and therefore a detailed description will be omitted.

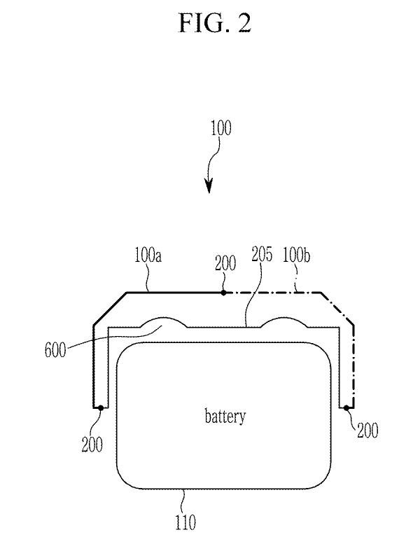

FIG. 2 is a cross-sectional view of FIG. 1, taken along the line II-II.

Referring to FIG. 2, the bicycle frame 100 includes a left panel 100a, a right panel 100b, a reinforcement panel 205, a housing unit 600, and a bonding portion 200.

In the left panel 100a and the right panel 100, the terms “left” and “right” are used to distinguish constituent elements, and thus are not substantially limited to the left side and the right side.

As hot-press or cold-press molded panel parts, the left panel 100a and the right panel 100b are bonded face-to-face such that the bonding portion 200 is formed. The bonding portion 200 may be formed by welding.

The reinforcement panel 205 forms a housing unit 600 where the battery 110 is received, an edge of one end of the reinforcement panel 205 is bonded along one edge of the left panel 100a, and an edge of the other end of the reinforcement panel 205 is bonded along an edge of the other end of the right panel 100b. Here, the housing unit 600 is opened downward, and the battery 110 is inserted to an upper side from a lower side.

In addition, the left panel 100a, the right panel 100b, and the reinforcement panel 205 have a pipe structure on a cross-section, and the bonding portion 200 is formed between the left panel 100a, the right panel 100b, and the reinforcement panel 205, and the bonding portion 200 may include a rivet bonding portion, a welded portion, or a hemming bonding portion.

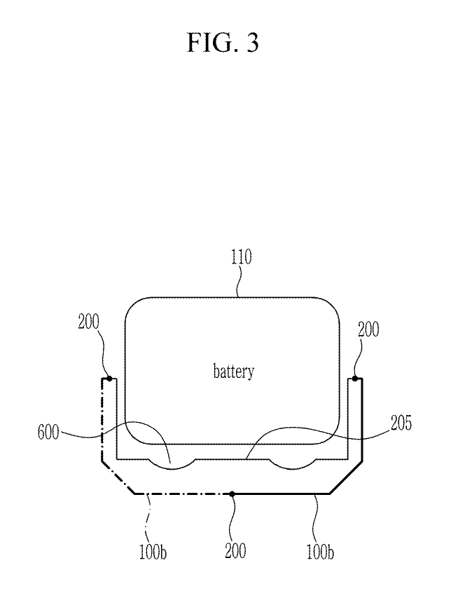

FIG. 3 is a cross-sectional view of FIG. 1, taken along the line II-II, and shows a portion where a battery is mounted in a bicycle frame in some forms of the present disclosure.

Referring to FIG. 3, a left panel 100a and a right panel 100b are bonded face-to-face such that a bonding portion 200 is formed.

A reinforcement panel 205 forms a housing unit 600 where a battery 110 is received, an edge of one end thereof is bonded along an edge of one end of the left panel 100a, and an edge of the other end thereof is bonded along an edge of the other end of the right panel 100b.

Here, the housing unit 600 is open upward, and the battery 110 is inserted to a lower side from an upper side.

In FIG. 2 and FIG. 3, the housing portion 600 is opened downwardly or upwardly, but this is not restrictive. The battery 110 may be inserted into the housing unit 600 in a lateral direction and the housing unit 600 may be opened in a lateral direction of the bicycle frame 100.

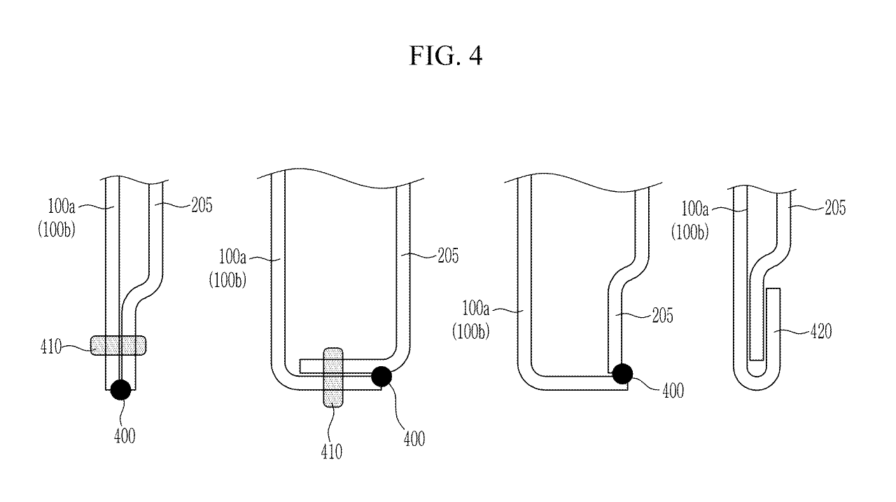

FIG. 4 is a cross-sectional view of a bonding structure between the left and right panels and the reinforcement panel of the bicycle frame in some forms of the present disclosure.

Referring to FIG. 4, the bonding portion 200 between an end of the left panel 100a and an end of the reinforcement panel 205 may be bonded by a rivet 410 and welding 400, or only welding 400 may be used.

In addition, instead of using the rivet 410 or the welding 400, the end of the left panel 100a or the end of the right panel 100b may be hemmed 420 and the hemmed portion may be bonded by being overlapped with the reinforcement panel 205.

Further, in another form of the present disclosure, an edge of the left panel and an edge of the right panel are surface-attached, and the surface-attached portion may be bonded by being spot welded.

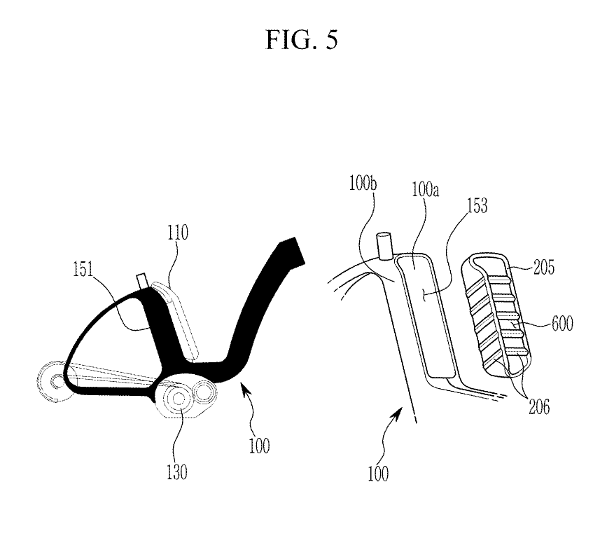

FIG. 5 is a side view and a partial exploded perspective view of a bicycle frame in another form of the present disclosure.

Referring to FIG. 5, a reinforcement panel 205 where a housing unit 600 is formed is inserted to a cutout 153 of a seat tube 151 of the bicycle frame, and an edge of the cutout 153 and an edge of the reinforcement panel 205 are bonded to each other.

Here, the reinforcement panel 205 is disposed at a front of the seat tube 151, but this is not restrictive. The reinforcement panel 205 may be disposed at a rear of the seat tube 151.

In addition, in some forms of the present disclosure, a bead 206 is formed at an internal side or an external side of the reinforcement panel 205 forming the housing unit 600 to improve rigidity of the reinforcement panel 205 and protect the battery 110 more strongly.

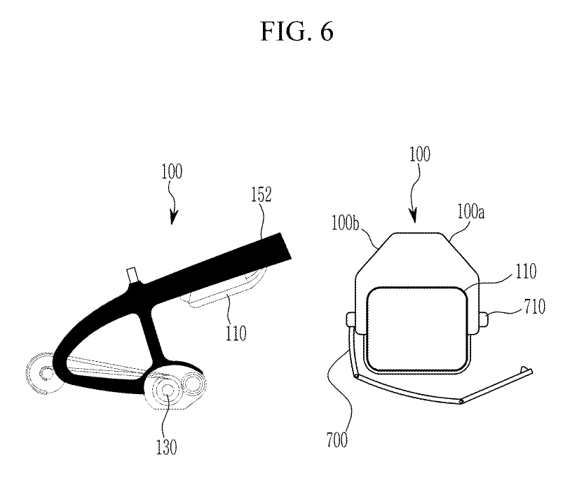

FIG. 6 is a side view and a cross-sectional view of a bicycle frame in another form of the present disclosure.

Referring to FIG. 6, a reinforcement panel 205 where a housing portion 600 is formed is disposed in a lower portion of a top tube or a main tube 152 of the bicycle frame, and a battery 110 is inserted into an upper side from a lower side.

Further, a separation prevention unit 700 that prevents the battery 110 from being separated to a lower portion in the housing unit 600 of the reinforcement panel 205 may be additionally provided.

The separation prevention unit 700 may be a strap made of a flexible material or a clamp folded and unfolded through a link structure, and one end of the separation prevention unit 700 is fixed to a left panel 100a and the other end is detachably attached to a right panel 100b through a detachable unit 710. The detachable portion is well known in the art, and a description thereof will be omitted.

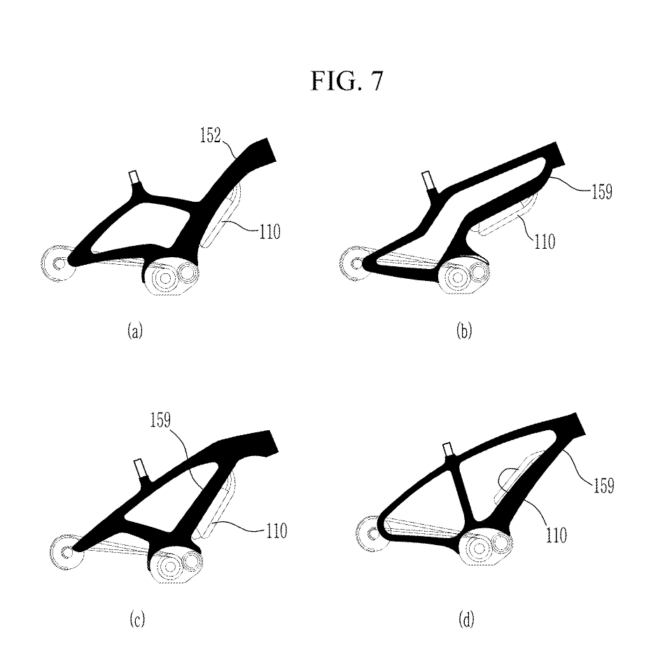

FIG. 7 shows side views of bicycle frames in some forms of the present disclosure.

Referring to FIG. 7, the battery 110 inserted into the housing unit 600 of the reinforcement panel 205 may be disposed in a lower portion of the main tube 152 as shown in (a), may be disposed in a lower portion of a down tube 159 as shown in (b) and (c), or may be disposed in an upper portion of the down tube 159 as shown in (d).

The description of the disclosure is merely exemplary in nature and, thus, variations that do not depart from the substance of the disclosure are intended to be within the scope of the disclosure. Such variations are not to be regarded as a departure from the spirit and scope of the disclosure.

### DESCRIPTION OF SYMBOLS

| | |
|---|---|
| 100: frame | 100a: left panel |
| 100b: right panel | 110: battery |
| 120: motor mounting unit | 130: motor unit |
| 150: head tube | 152: main tube |
| 156: seat stay | 154: chain stay |
| 200: bonding portion | 205: reinforcement panel |
| 400: welding | 410: rivet |
| 420: hem | 600: housing unit |
| 700: separation prevention unit | 710: detachable unit |

What is claimed is:

1. A bicycle frame formed in a tube structure by bonding a left panel and a right panel together along a length direction, where the left panel and the right panel are molded into a predetermined shape, comprising:
a battery housing unit; and
a reinforcement panel having a housing unit;
wherein a battery is inserted into the housing unit, and
wherein edges of the reinforcement panel are bonded to the left panel and the right panel.

2. The bicycle frame of claim 1, wherein:
the reinforcement panel is configured to combine at least one of a top tube, a seat tube, or a main tube with a down tube, and
the down tube is connected to a head tube where a steering handle is provided.

3. The bicycle frame of claim 2, wherein:
a motor mounting unit is formed in at least one of a lower portion of the down tube or the top tube, and
a motor for driving is provided in the motor mounting unit.

4. The bicycle frame of claim 1, wherein:
the housing unit is opened downwardly such that the battery is inserted into the housing unit from a bottom direction to a top direction.

5. The bicycle frame of claim 1, wherein:
the housing unit is opened upwardly such that the battery is inserted into the housing unit from the top direction to the bottom direction.

6. The bicycle frame of claim 1, wherein:
the housing unit is opened laterally such that the battery is laterally inserted into the housing unit.

7. The bicycle frame of claim 1, wherein:
the reinforcement panel and at least one of the left panel or the right panel are bonded to each other by a rivet.

8. The bicycle frame of claim 1, wherein:
the reinforcement panel and at least one of the left panel or the right panel are welded to each other.

9. The bicycle frame of claim 1, wherein:
the left panel or the right panel is bonded to the reinforcement panel by hemming.

10. The bicycle frame of claim 1, further comprising:
a separation prevention unit, wherein one end of the separation prevention unit is fixed to at least one of the left panel or the right panel and the other end of the separation prevention unit is detachably attached to at least one of the right panel or the left panel to prevent the battery from being separated from the housing unit.

11. The bicycle frame of claim 10, wherein:
the separation prevention unit is a strap made of a flexible material or a clamp that is capable of being folded and unfolded through a link structure.

12. The bicycle frame of claim 11, comprising:
a detachable unit configured to fix the other end of the strap or the clamp to the right panel or the left panel.

13. The bicycle frame of claim 1, wherein:
a bead is formed in an inner surface or an outer surface of the reinforcement panel.
